(19) United States
(12) Patent Application Publication
(10) Pub. No.: US 2022/0169480 A1
(43) Pub. Date: Jun. 2, 2022

(54) ELEVATOR SYSTEM

(71) Applicant: HITACHI, LTD., Tokyo (JP)

(72) Inventors: Tomoaki MAEHARA, Tokyo (JP); Koichi YAMASHITA, Tokyo (JP); Yuki SAITO, Tokyo (JP); Toshiharu MATSUKUMA, Tokyo (JP); Takahiro HATORI, Tokyo (JP); Satoru TORIYABE, Tokyo (JP); Hayate TANABAYASHI, Tokyo (JP)

(21) Appl. No.: 17/598,340

(22) PCT Filed: Oct. 24, 2019
(86) PCT No.: PCT/JP2019/041772

§ 371 Date: Sep. 27, 2021

(30) Foreign Application Priority Data
Mar. 28, 2019 (JP) 2019-064031

(51) Int. Cl. B66B 1/34; B66B 5/02; B66B 1/28; B66B 11/02; B66B 3/00

(52) U.S. Cl. CPC B66B 1/34; B66B 5/027; B66B 1/28; B66B 2201/30; B66B 11/0226; B66B 1/3461; B66B 3/002; B66B 1/3492

(57) ABSTRACT

An elevator system includes a car that ascends and descends a hoist way, a power feeding device installed at a specific power feeding point of the hoist way, a power receiving device that receives power from the power feeding device when the car stops at the power feeding point, a battery that is charged by the received power, and an elevator control panel that controls ascent and descent of the car. When the remaining capacity of the battery is equal to or less than a predetermined capacity, the elevator control panel performs a rescue operation of a passenger in the car, and after the rescue operation, performs an automatic search operation of searching for a power feeding point where the power feeding device is installed according to the remaining capacity of the battery.

### TECHNICAL FIELD

The present invention relates to an elevator system.

### BACKGROUND ART

A car of a conventional elevator receives power supply through a tail cord connecting a power source installed on a hoist way side and a car, and operates lighting, an air conditioner, and the like in the car, which are devices in the car, with the power obtained through the tail cord. However, when the car provides a service in a long course, the weight of the tail code affects the movement of the car. For this reason, an elevator having a reduced power supply function to the car through the tail cord has been developed.

Such an elevator is configured to operate a device in the car by power supplied from a battery installed in the car. Then, when the car stops on a specific floor such as the first floor, power is supplied to the battery in the car from the power feeding device installed on the floor via the power receiving device on the car side in a non-contact manner, and the battery is charged.

PTL 1 describes an example of an elevator including a power feeding device for performing contactless power feeding to a car.

### CITATION LIST

### Patent Literature

PTL 1: JP 2012-175857 A

### SUMMARY OF INVENTION

### Technical Problem

When contactless power feeding is performed on a car of an elevator, a power feeding floor on which a power feeding device is installed is generally a limited floor such as a first floor. Then, when the remaining amount of power of a power storage device decreases, the car moves to the power feeding floor in the hoist way and stops, and contactless power feeding is performed from the power feeding device installed on the power feeding floor to the power storage device.

Incidentally, the elevator car performs control of the elevating position with high accuracy during normal operation. That is, the stop state is realized with accuracy in which the floor on the landing side and the floor of the car substantially coincide with each other at the time of stopping to each floor.

However, when an unexpected situation such as the occurrence of an earthquake or the occurrence of a power failure occurs, the accurate elevating position of the car may be unknown. That is, there is a case where the car is suddenly stopped for safety at the time of an earthquake or a power failure, and when such a sudden stop occurs, the control device may lose the position of the car. In addition, when an abnormality occurs in communication between the elevator control panel and the car or an abnormality occurs in the car position detection device, the control device may lose the position of the car.

When such a situation occurs in an elevator that performs contactless power feeding, or when a power feeding point cannot be temporarily detected due to dust generated in an elevator hoist way, there is a possibility that the car cannot stop at the power feeding floor.

An object of the present invention is to provide an elevator system capable of returning to a normal operation state as much as possible even when an accurate elevating position of a car becomes unclear in a case of performing contactless power feeding to the car.

### Solution to Problem

In order to solve the above problem, the configurations disclosed in claims are employed for example.

The present application includes a plurality of aspects for solving the above problems, and examples thereof include an elevator car that ascends or descends a hoist way, a power feeding device installed at a specific power feeding point of the hoist way, a power receiving device installed in the car and receiving power from the power feeding device when the elevator car stops at the power feeding point, a battery charged with the power received by the power receiving device, and an elevator control panel that controls ascent or descent of the car.

When the battery is equal to or less than a predetermined remaining capacity, the elevator control panel performs a rescue operation of a passenger in the car, and after the rescue operation, performs an automatic search operation of searching for a power feeding point where the power feeding device is installed according to the remaining capacity of the battery.

According to the present invention, when a situation in which the car cannot detect the power feeding point occurs in a state in which the battery installed in the car is depleted, the power feeding point can be automatically searched after rescuing the passenger of the car, and the normal operation state can be restored.

Objects, configurations, and effects besides the above description will be apparent through the explanation on the following embodiments.

### BRIEF DESCRIPTION OF DRAWINGS

FIG. 1 is a configuration diagram illustrating an example of a power supply configuration to a car according to an embodiment of the present invention.

FIG. 2 is a schematic view illustrating an arrangement example of a hoist way according to an embodiment of the present invention.

FIG. 3 is a block diagram illustrating an example of a control configuration according to an embodiment of the present invention.

FIG. 4 is a block diagram illustrating a hardware configuration example of an elevator control panel according to an embodiment of the present invention.

FIG. 5 is a flowchart illustrating an example of movement processing to a power feeding floor according to an embodiment of the present invention.

FIG. 6 is a flowchart illustrating an example of automatic search processing of a power feeding point according to an embodiment of the present invention.

FIG. 7 is a flowchart illustrating an example of manual search processing for a power feeding point according to an embodiment of the present invention.

FIG. 8 is a schematic view illustrating an example in which a plurality of cars is installed, which is an example of a hoist way according to another embodiment of the present invention.

### DESCRIPTION OF EMBODIMENTS

Hereinafter, an embodiment of the present invention will be described in detail with reference to the accompanying drawings. In the following description, an embodiment of the present invention will be referred to as this example.

### [1. Configuration of Entire System]

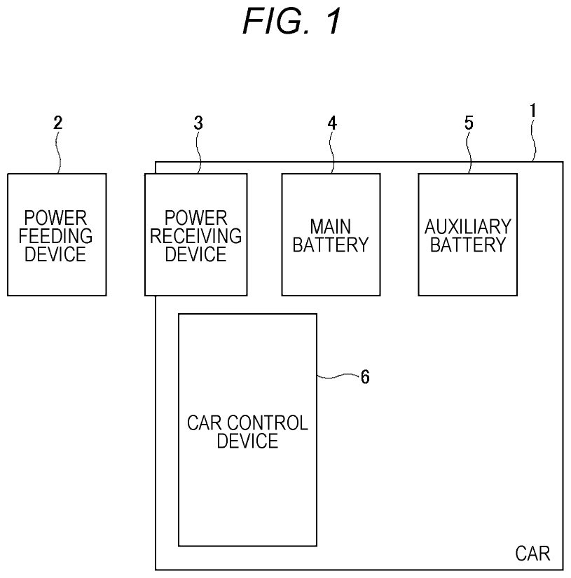

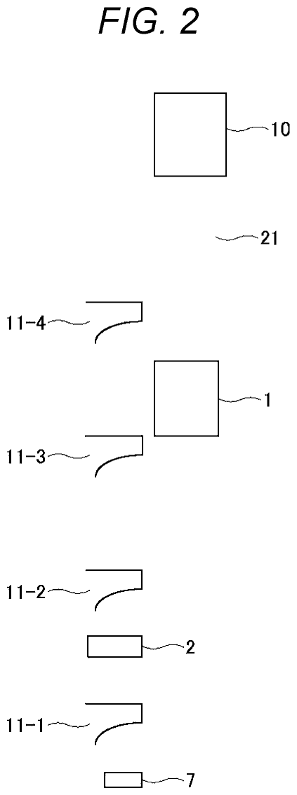

FIG. 1 illustrates a configuration of a car 1 included in an elevator system of this example. FIG. 2 illustrates an arrangement example of the car 1.

As illustrated in FIG. 2, the elevator system of this example includes the car 1 that ascends and descends a hoist way 21, and an elevator control panel 10 that controls information and descent of the car 1. The elevator control panel 10 is disposed above the hoist way 21 or in a machine room (not illustrated). The car 1 moves up and down between landings 11-1 to 11-4 of a plurality of floors. Further, a car position correction mechanism 7 is installed at a specific position of the hoist way 21, which is a position slightly lower than the lowermost floor in the example of FIG. 2. The car position correction mechanism 7 sets a reference elevating position of the car 1, and a sensor installed in the car 1 detects the car position correction mechanism 7 to set the reference elevating position. As illustrated in FIG. 1, the car position correction mechanism 7 is provided at a position slightly lower than the lowermost floor as an example, and the car position correction mechanism 7 may be installed at another position of the hoist way 21. Further, the car position correction mechanism 7 may be installed at a plurality of places of the hoist way 21.

In FIG. 2, a mechanism for raising and lowering the car 1 is not illustrated. For example, the main rope is not illustrated in FIG. 2. Although not illustrated, in the manager's room in a building in which the elevator system of this example is installed, a display device that displays the operation status of the elevator and the like in response to an instruction from the elevator control panel 10 is installed.

In the elevator system of this example, power is supplied to the car 1 in a non-contact manner, and a cord for supplying power to the car 1 from the outside is not arranged in the hoist way 21.

As illustrated in FIG. 2, a power feeding device 2 is installed on a specific floor in the hoist way 21. The position where the power feeding device 2 is installed is referred to as a power feeding point, and the floor where the power feeding point is installed is referred to as a power feeding floor. Here, the position of the power feeding point is a position viewed from an elevating direction in the hoist way 21.

The power feeding point is a position at which the power feeding device 2 and a power receiving device 3 (FIG. 1) on the car 1 side are accurately aligned. However, even in a case where the car 1 stops at the power feeding floor, when the stop position is shifted by about several centimeters, it is conceivable that the car 1 is not stopped at the power feeding point.

In FIG. 2, one floor in the hoist way 21 is set as the power feeding floor in order to simplify the description, but a plurality of power feeding devices 2 may be installed in the hoist way 21, and a plurality of floors may be set as the power feeding floors.

As illustrated in FIG. 1, the power receiving device 3, a main battery 4, an auxiliary battery 5, and a car control device 6 are installed in the car 1.

FIG. 1 illustrates a case where the car 1 stops at the power feeding point, and in this state, the power receiving device 3 installed in the car 1 faces the power feeding device 2 on the hoist way 21 side with a slight gap. When the car 1 stops at the power feeding point and the power receiving device 3 faces the power feeding device 2 in this manner, the sensor on the power feeding device 2 side detects that the facing state and confirms that the detection signal is obtained, so that the power feeding is performed. A sensor on the power receiving device 3 side may detect the facing state.

A coil for power transmission is disposed in the power feeding device 2, a coil for power reception is disposed in the power receiving device 3, and power transmission is performed in a non-contact manner between the coil for power transmission and the coil for power reception which face. This power transmission in a non-contact manner is performed by a command from the elevator control panel 10 (FIG. 2).

The car control device 6 installed in the car 1 charges the main battery 4 and the auxiliary battery 5 with the power obtained by the power receiving device 3. The equipment in the car 1 is operated by power from the main battery 4. Examples of the equipment in the car 1 include lighting equipment, air conditioning equipment, door driving equipment, and an interphone.

The car control device 6 is also operated by power from the main battery 4. As the main battery 4, for example, a secondary battery that can drive the equipment in the car 1 for several tens of minutes is used.

The auxiliary battery 5 supplies minimum power to the equipment in the car 1 when power stored in the main battery 4 runs out or when the main battery 4 fails. As the auxiliary battery 5, a secondary battery having a smaller capacity than the main battery 4 is used. The auxiliary battery 5 is always used in a substantially fully charged state.

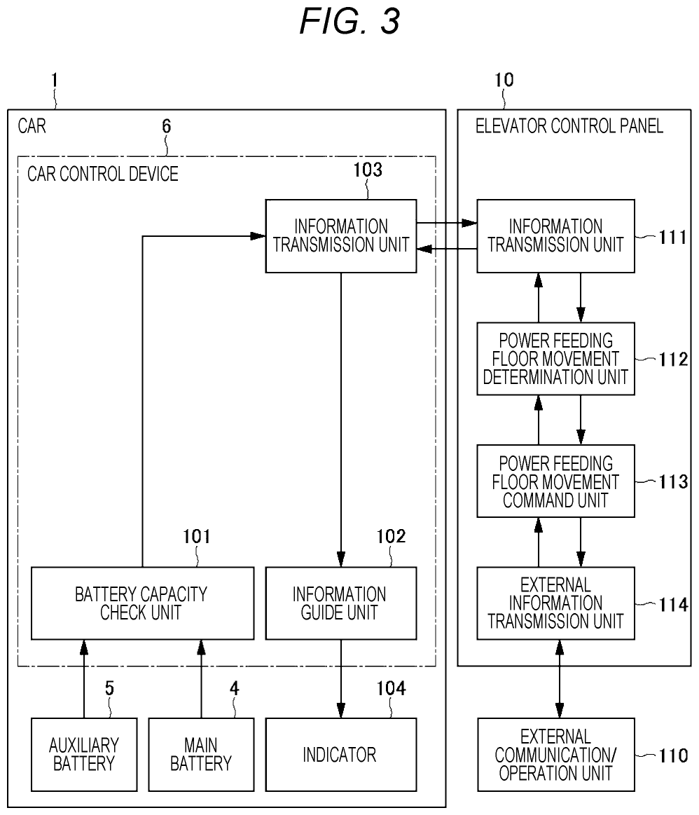

FIG. 3 illustrates a control configuration of the elevator control panel 10 and the car control device 6.

The car control device 6 installed in the car 1 includes a battery capacity check unit 101, an information guide unit 102, and an information transmission unit (car-side information transmission unit) 103.

The battery capacity check unit 101 checks the remaining charge amounts of the main battery 4 and the auxiliary battery 5 installed in the car 1. The information guide unit 102 controls display on an indicator 104 installed in the car 1. The indicator 104 performs various guidance displays for passengers, such as displaying a stop floor of the car 1. As one of guidance displaying by the indicator 104, there is displaying (unavailable displaying) indicating that the elevator is unavailable at some abnormality. In addition, the information guide unit 102 also performs processing of notifying the passenger that the elevator cannot be used due to ringing of a buzzer or the like when performing the unavailable displaying on the indicator 104.

The elevator control panel 10 includes an information transmission unit (control panel side information transmission unit) 111, a power feeding floor movement determination unit 112, a power feeding floor movement command unit 113, and an external information transmission unit 114.

The information transmission unit 111 performs bidirectional data transmission with the information transmission unit 103 in the car 1. The data transmission between the information transmission units 103 and 111 is performed by wired cable communication or wireless communication.

The power feeding floor movement determination unit 112 determines whether the car 1 has moved to the power feeding floor.

The power feeding floor movement command unit 113 commands the car 1 to move to the power feeding floor when the car 1 needs to move to the power feeding floor based on the remaining charge amount of the main battery 4 or the like. The command to move the car to the power feeding floor generated by the power feeding floor movement command unit 113 is transmitted to the car control device 6 in the car 1 and transmitted to a drive control device that drives the car 1, and the car 1 is raised or lowered to move to the corresponding power feeding floor. In FIG. 3, the drive control device that drives the car 1 is not illustrated.

The external information transmission unit 114 displays the operation status of the car 1 and the like on an external communication/operation unit 110 connected to the elevator control panel 10, and transmits the operation command received by the external communication/operation unit 110 to the power feeding floor movement command unit 113. The external communication/operation unit 110 communicates with the outside such as a monitoring center of the elevator. In addition to a configuration in which the operation command from the external communication/operation unit 110 directly reaches the elevator control panel 10, a configuration in which the operation command remotely reaches the elevator control panel from an operation unit installed in a remote place such as a manager's room may be adopted.

### [2. Hardware Configuration Example of Elevator Control Panel]

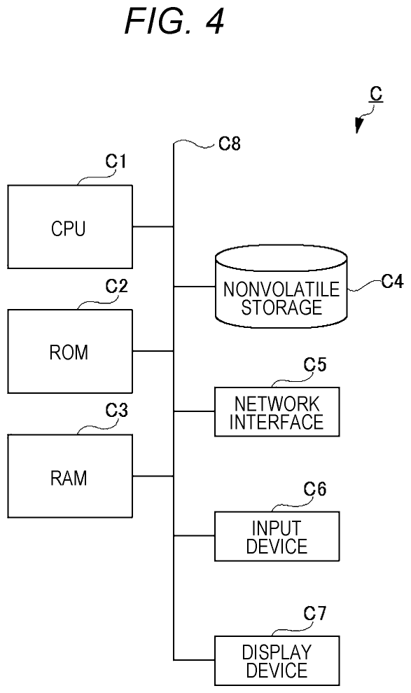

The elevator control panel 10 can be configured by, for example, a computer illustrated in FIG. 4.

A computer C illustrated in FIG. 4 includes a central processing unit (CPU) C1, a read only memory (ROM) C2, and a random access memory (RAM) C3, each of which is connected to a bus C8. The computer C further includes a nonvolatile storage C4, a network interface C5, an input device C6, and a display device C7.

The CPU C1 is an arithmetic processing unit that reads a program code of software for realizing the function performed by the elevator control panel 10 from the ROM C2 and executes the program code. The power feeding floor movement determination unit 112 and the power feeding floor movement command unit 113 illustrated in FIG. 3 are also configured by the CPU C1 reading the corresponding programs.

Variables, parameters, and the like generated during arithmetic processing are temporarily written to the RAM C3.

As the input device C6, for example, a keyboard, a mouse, or the like is used. In the case of the elevator control panel 10, a maintenance person performs an operation using the input device C6.

The display device C7 is, for example, a liquid crystal display monitor, and a result of control processing executed by the computer is displayed by the display device C7.

Note that the input device C6 and the display device C7 are also used at the time of operation and display in the manager's room.

As the nonvolatile storage C4, for example, a large-capacity information storage medium such as a hard disk drive (HDD) or a solid state drive (SSD) is used. A program for executing a processing function performed by the elevator control panel 10 is recorded in the nonvolatile storage C4.

As the network interface C5, for example, a network interface card (NIC) or the like is used. The network interface C5 transmits and receives various types of information to and from the outside via a local area network (LAN), a dedicated line, or the like.

Note that the elevator control panel 10 is an example configured by the computer illustrated in FIG. 4, and may be configured by another arithmetic processing device other than the computer. For example, some or all of the functions performed by the elevator control panel 10 may be realized by hardware such as a field programmable gate array (FPGA) or an application specific integrated circuit (ASIC).

The car control device 6 installed in the car 1 may also be configured by a computer illustrated in FIG. 4.

### [3. Movement Processing of Car to Power Feeding Floor]

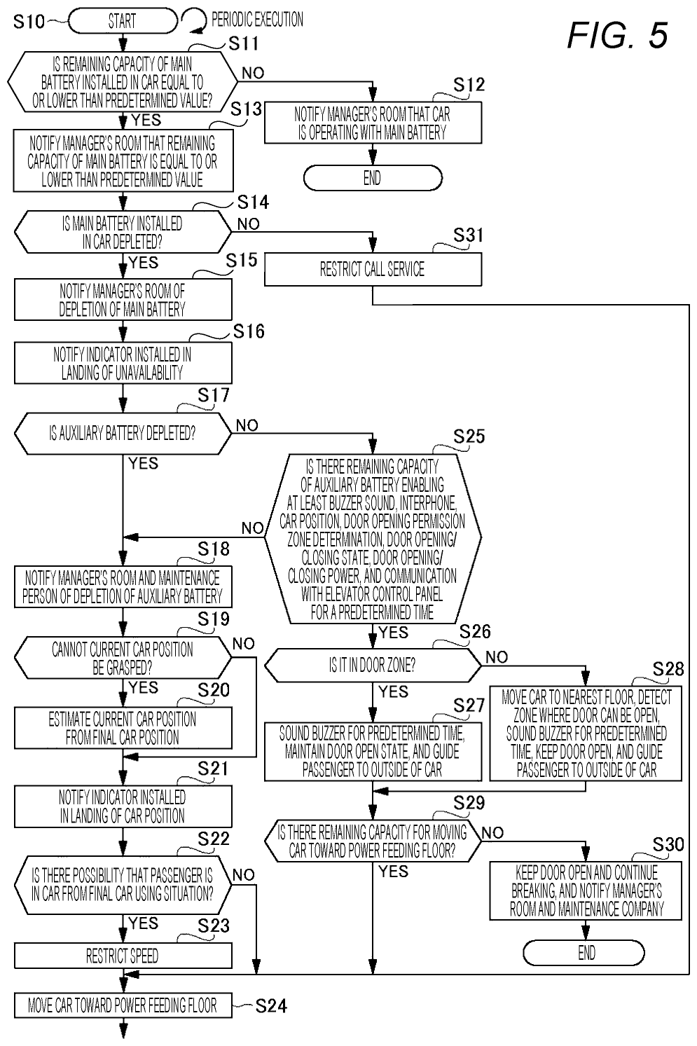

FIG. 5 is a flowchart illustrating a flow of processing of moving the car 1 to the power feeding floor by a command from the power feeding floor movement command unit 113.

First, the power feeding floor movement command unit 113 periodically starts processing of moving the car 1 to the power feeding floor (Step S10). When the processing of moving the car 1 to the power feeding floor is started, the power feeding floor movement command unit 113 acquires information on the remaining capacity of the main battery 4 installed in the car 1 from the car control device 6, and determines whether the acquired remaining capacity is equal to or less than a predetermined value which is a threshold value requiring charging (Step S11). The predetermined value here is, for example, a value when the remaining capacity (charge capacity) of the main battery 4 becomes, for example, 20% or less.

Here, when the remaining capacity of the main battery 4 is not equal to or less than the threshold (NO in Step S11), the elevator control panel 10 performs notification processing of displaying that the elevator is operating with the main battery on the display device in the manager's room of the building (Step S12), and ends the movement processing to the power feeding floor.

Then, when it is determined in Step S11 that the remaining capacity of the main battery 4 is equal to or less than the threshold (YES in Step S11), the power feeding floor movement command unit 113 performs notification processing of displaying that the remaining capacity of the main battery 4 has decreased to a predetermined value or less on the display device in the manager's room of the building (Step S13).

After this notification processing, the power feeding floor movement command unit 113 determines whether the main battery 4 is in a depleted state (Step S14). Here, the state in which main battery 4 is depleted refers to a state in which power supply from the main battery 4 is hardly possible in a state in which the remaining capacity of main battery 4 is very small, such as 10% or less.

When it is determined in Step S14 that the main battery 4 is not in a depleted state (NO in Step S14), the elevator control panel 10 restricts the reception of the car 1 for the landing call service at each of the landings 11-1 to 11-4 of the car 1, and sets a situation in which a passenger cannot get on the car 1 (Step S31). When two or more cars are provided together, the landing call already registered in the car 1 is allocated to another car and changed. Then, the power feeding floor movement command unit 113 moves the car 1 to the power feeding floor (Step S24).

On the other hand, when it is determined in Step S14 that the main battery 4 is in a depleted state (YES in Step S14), the elevator control panel 10 performs notification processing of displaying that the main battery 4 is depleted on the display device in the manager's room of the building (Step S15). Further, the elevator control panel 10 performs notification processing of displaying the elevator unavailability of the car 1 on the indicators of all the landings 11-1 to 11-4 of the car 1 (Step S16).

After that, the power feeding floor movement command unit 113 determines whether the auxiliary battery 5 is in a depleted state (Step S17). Here, the state in which auxiliary battery 5 is depleted refers to a state in which the auxiliary battery 5 is not charged to such an extent that the facility equipment in the car 1 cannot be operated.

If it is determined in Step S17 that the auxiliary battery 5 is in a depleted state (YES in Step S17), the power feeding floor movement command unit 113 performs notification processing in which the elevator control panel 10 displays that the auxiliary battery is depleted on the display device in the manager's room of the building (Step S18).

Then, the power feeding floor movement command unit 113 determines whether the car control device 6 on the car 1 side cannot grasp the elevating position of the car 1 (Step S19). Here, when the elevating position of the car 1 cannot be grasped (YES in Step S19), the power feeding floor movement command unit 113 estimates the current elevating position of the car 1 from the elevating position of the car 1 determined last by the car control device 6 (Step S20).

Then, when it is determined in Step S19 that the elevating position of the car 1 can be grasped (NO in Step S19), after the current elevating position of the car 1 is estimated in Step S20, the elevator control panel 10 performs notification processing of displaying the car position on the display installed in each of the landings 11-1 to 11-4 (Step S21).

Further, the elevator control panel 10 determines whether there is a possibility that there is a passenger in the car 1 from the final use state of the car 1 (Step S22). Here, the possibility that there is a passenger in the car 1 is determined from, for example, a detection value of a load sensor installed in the car 1, an image of a camera in the car, presence or absence of destination floor registration in the car, presence or absence of operation on a button installed in the car, presence or absence of detection of a sensor installed in the car, and the like.

When it is determined in Step S22 that there is a possibility that there is a passenger (YES in Step S22), the power feeding floor movement command unit 113 limits the elevating speed of the car 1 to a speed lower than the normal time (Step S23).

Then, when it is determined in Step S22 that there is no possibility that there is a passenger (NO in Step S22), the power feeding floor movement command unit 113 moves the car 1 to the power feeding floor (Step S24). Even when the speed limitation processing is performed in Step S23, the power feeding floor movement command unit 113 causes the power feeding floor movement command unit 113 to move the car 1 to the power feeding floor in a state where the speed is limited (Step S24).

When it is determined in Step S17 that the auxiliary battery 5 is not in a depleted state (NO in Step S17), the power feeding floor movement command unit 113 determines whether the remaining capacity of the auxiliary battery 5 enables at least power supply for temporarily and appropriately operating the car 1 (Step S25). Here, the state in which power supply for temporarily and appropriately operating the car 1 can be performed refers to, for example, a state in which there is a remaining capacity of the auxiliary battery 5 enough to enable buzzer sound in the car 1, driving of an interphone, car position determination, door opening permission zone determination, door opening/closing state determination, door opening/closing power, and communication with the elevator control panel 10 for a predetermined time (at least several minutes).

In Step S25, when it is determined that power supply for temporarily and appropriately operating the car 1 is not possible (NO in Step S25), the process proceeds to Step S18 described above. If it is determined in Step S25 that the power supply for temporarily and appropriately operating the car 1 is possible (YES in Step S25), the power feeding floor movement command unit 113 determines whether the current elevating position of the car 1 is in a door zone (Step S26). Here, the door zone indicates a range in which the door of the car 1 and the door of the landing can be opened and closed.

Then, when it is determined in Step S26 that it is the door zone (YES in Step S26), the power feeding floor movement command unit 113 causes the buzzer in the car 1 to sound and maintains the door open state for a predetermined time, and guides the passenger in the car 1 to the outside of the car (Step S27).

In addition, in a case where it is determined in Step S26 that it is not the door zone (NO in Step S26), the power feeding floor movement command unit 113 moves the car 1 to the nearest floor of the current position. When the elevating position of the car 1 becomes the door zone by the movement of the car 1 to the nearest floor, the power feeding floor movement command unit 113 causes the buzzer in the car to sound and maintains the door open state for a predetermined time, and guides the passenger in the car 1 to the outside of the car (Step S28).

After the guidance of the passenger to the outside of the car in Steps S27 and S28, the power feeding floor movement command unit 113 determines whether there is a remaining capacity that can be driven by the auxiliary battery 5 while the car 1 is moved to the power feeding floor (Step S29). Here, when it is determined that the remaining capacity of the auxiliary battery 5 is exhausted while the car 1 is moved to the power feeding floor (NO in Step S29), the power feeding floor movement command unit 113 continues a braking state in which the car 1 is stopped and the brake is applied in the door open state in the car 1, and displays that the operation is stopped due to the battery depletion on the display device in the manager's room (Step S30). At this time, the elevator control panel 10 notifies an external monitoring center monitoring the operation of the elevator that the operation is stopped due to battery depletion. The monitoring center is installed, for example, by a company that performs maintenance of an elevator.

When it is determined in Step S29 that the auxiliary battery 5 has the remaining capacity that can be driven to the power feeding floor (YES in Step S29), the power feeding floor movement command unit 113 moves the car 1 to the power feeding floor (Step S24).

### [4. Processing of Automatic Search for Power Feeding Point]

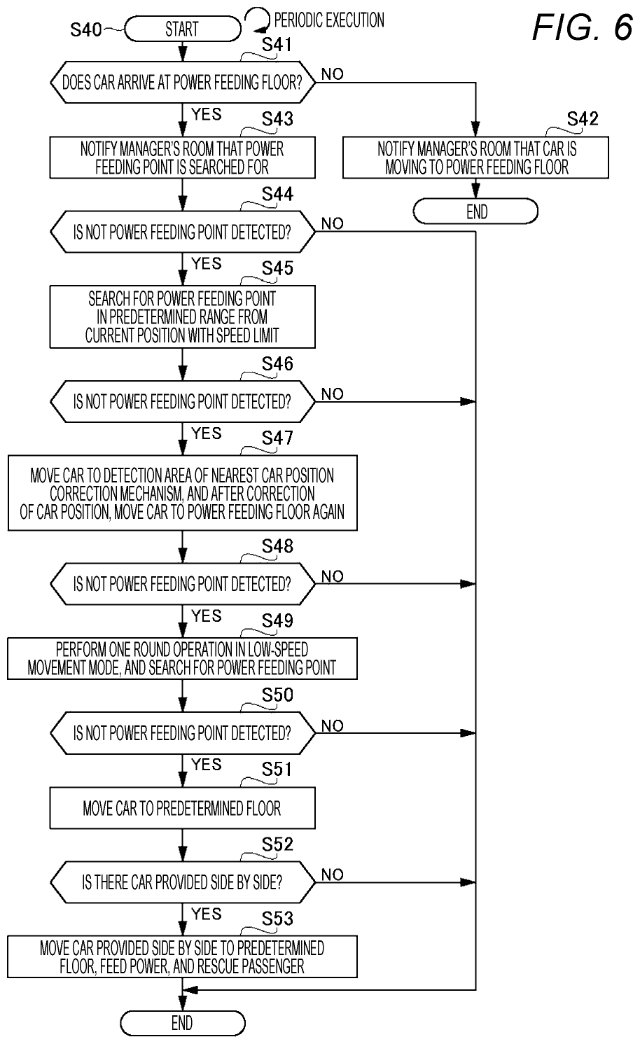

Next, with reference to the flowchart of FIG. 6, the flow of processing in which the car 1 automatically searches for the power feeding point after the power feeding floor movement command unit 113 starts the movement of the car 1 to the power feeding floor in Step S24 of the flowchart of FIG. 5 will be described.

First, when the movement of the car 1 to the power feeding floor according to the instruction of the power feeding floor movement command unit 113 is started, the power feeding floor movement determination unit 112 periodically starts the automatic search processing (Step S40).

When the automatic search processing is started, the power feeding floor movement determination unit 112 determines whether the car 1 has arrived at the power feeding floor (Step S41).

If the arrival at the power feeding floor is not detected in Step S41 (NO in Step S41), the power feeding floor movement determination unit 112 performs notification processing of displaying the movement to the power feeding floor on the display device in the manager's room (Step S42), and ends the automatic search processing here. Then, the power feeding floor movement determination unit 112 waits until the start timing of the automatic search processing in the next Step S40.

When the arrival at the power feeding floor is detected in Step S41 (YES in Step S41), the power feeding floor movement determination unit 112 performs notification processing of displaying that the power feeding point is being searched on the display device of the manager's room (Step S43). Thereafter, the power feeding floor movement determination unit 112 determines whether the car 1 has not detected the power feeding point (Step S44). Here, when the car 1 detects the power feeding point (NO in Step S44), the automatic search is ended, and the process proceeds to the power feeding processing at the power feeding point. Note that description of the power feeding processing is omitted.

When it is determined in Step S44 that the power feeding point cannot be detected by the car 1 (YES in Step S44), the power feeding floor movement command unit 113 searches for the power feeding point by moving the car 1 at a very low speed with a speed limited in a predetermined range, for example, a range of several tens of centimeters, starting from the current position where the car 1 has arrived at the power feeding floor (Step S45).

The power feeding floor movement determination unit 112 also determines whether the car 1 has not detected the power feeding point in the search for the power feeding point in Step S45 (Step S46). Here, when the car 1 detects the power feeding point (NO in Step S46), the automatic search is ended, and the process proceeds to the power feeding processing at the power feeding point.

When it is determined in Step S46 that the power feeding point of the car 1 cannot be detected (YES in Step S46), the power feeding floor movement command unit 113 moves to the detection area of the nearest car position correction mechanism 7 in the hoist way 21, corrects the reference elevating position of the car position, and then moves the car to the power feeding floor again (Step S47).

The power feeding floor movement determination unit 112 also determines whether the car 1 has not detected the power feeding point in the search for the power feeding point in Step S47 (Step S48). Here, when the car 1 detects the power feeding point (NO in Step S48), the automatic search is ended, and the process proceeds to the power feeding processing at the power feeding point.

When it is determined in Step S48 that the car 1 cannot detect the power feeding point (YES in Step S48), the power feeding floor movement command unit 113 performs one round operation of the car 1 in a low-speed operation mode and searches for the power feeding point (Step S49). Here, the one round operation is an operation of moving the car 1 from the lowermost floor to the uppermost floor of the hoist way 21.

The power feeding floor movement determination unit 112 also determines whether the car 1 has not detected the power feeding point in the search for the power feeding point in Step S49 (Step S50). Here, when the car 1 detects the power feeding point (NO in Step S50), the automatic search is ended, and the process proceeds to the power feeding processing at the power feeding point.

When it is determined in Step S50 that the power feeding point of the car 1 cannot be detected (YES in Step S50), the power feeding floor movement command unit 113 moves the car 1 to a predetermined floor determined in advance (Step S51). Thereafter, the power feeding floor movement command unit 113 determines whether there is another car provided side by side with the car 1 (Step S52). Here, in a case where there is no other cars provided side by side, the automatic search is ended.

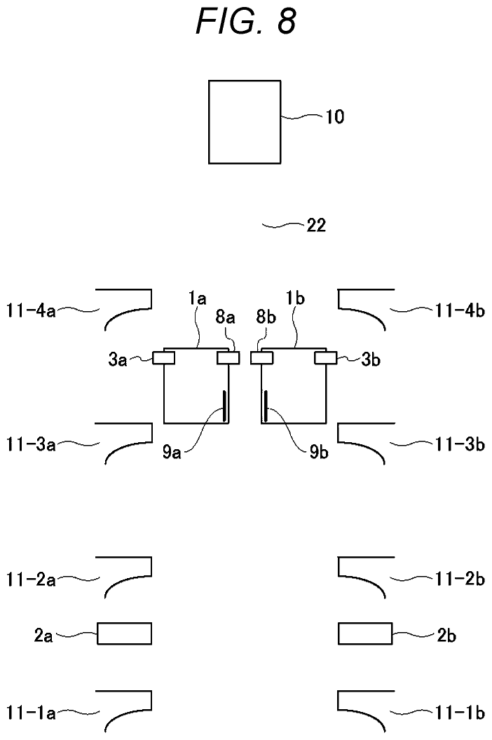

In addition, in a case where it is determined in Step S52 that there is another car provided side by side with the car 1 (YES in Step S52), the other car is moved to the same predetermined floor, power is supplied to the car 1 from the other car, and in a case where there is a passenger, passenger rescue processing is performed, and the automatic search is ended (Step S53). A specific example of the power feeding and the rescue processing using another car in Step S53 will be described later (FIG. 8).

### [5. Processing of Manually Searching for Power Feeding Point]

When the power feeding point cannot be detected in the automatic search processing described in the flowchart of FIG. 6, the power feeding floor movement command unit 113 of the elevator control panel 10 proceeds to manual search processing for the power feeding point.

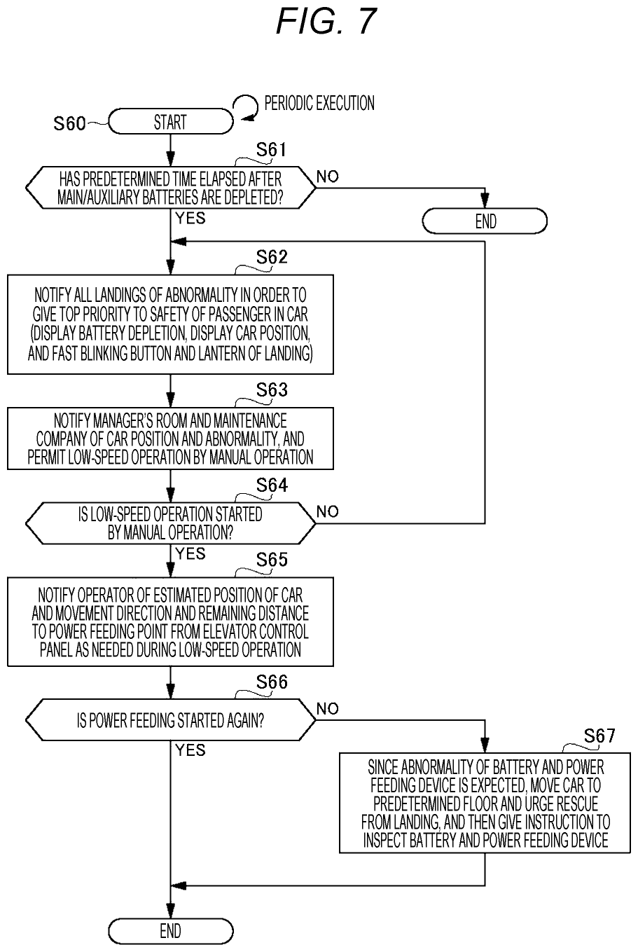

FIG. 7 is a flowchart illustrating a flow of manual search processing for a power feeding point.

The power feeding floor movement command unit 113 periodically starts manual search processing (Step S60). When the manual search processing is started, the power feeding floor movement command unit 113 determines whether a predetermined time has elapsed since both the main battery 4 and the auxiliary battery 5 are depleted (Step S61). The predetermined time here is, for example, a time required for the automatic search in the flowchart of FIG. 6.

If it is determined in Step S61 that the predetermined time has not elapsed (NO in Step S61), the manual search processing here is ended, and the process waits until the start timing of the next manual search processing in Step S60.

Then, when it is determined in Step S61 that the predetermined time has elapsed (YES in Step S61), the power feeding floor movement command unit 113 notifies the indicators in all the landings of the abnormality in order to give top priority to safety of the passengers in the car 1 (Step S62). As the notification of the abnormality here, for example, battery depletion is displayed, and the car position display, the landing button, and the arrival notification lantern are blinked at a high speed.

Thereafter, the abnormality of the corresponding elevator is notified to the display device in the manager's room and the monitoring center of the maintenance company, and the power feeding floor movement command unit 113 permits the low-speed operation of the car 1 by the manual operation (Step S63). When the low-speed operation is permitted, the manager of the building or the maintenance person of the maintenance company operates the car 1 at a low speed by a manual operation by a button operation or the like arranged in the external communication/operation unit 110 connected to the elevator control panel 10.

Thereafter, the power feeding floor movement command unit 113 determines whether the low-speed operation by the manual operation has started (Step S64). Here, when the start of the low-speed operation by the manual operation is not determined (NO in Step S64), the power feeding floor movement command unit 113 repeats the process from Step S62.

Then, when it is determined in Step S64 that the low-speed operation is started by the manual operation (YES in Step S64), the power feeding floor movement determination unit 112 performs notification processing of displaying the operation status on the external communication/operation unit 110 of the elevator control panel 10 as needed (Step S65). Here, the notification processing of displaying on the external communication/operation unit 110 as needed is, for example, processing of displaying the current estimated position of the car 1, the moving direction to the power feeding point, and the remaining distance to the power feeding point.

Thereafter, the elevator control panel 10 determines whether the power feeding from the power feeding device 2 to the power receiving device 3 is resumed (Step S65). Here, when it is determined that the power feeding is resumed (YES in Step S65), the manual search processing is ended.

When it is determined in Step S65 that the power feeding is not resumed (NO in Step S65), abnormality of the battery or the power feeding device is assumed, and thus, the power feeding floor movement determination unit 112 moves the car 1 to a predetermined floor. Then, the elevator control panel 10 urges rescue of a passenger from the landing by a display on the external communication/operation unit 110, and then gives an instruction to inspect the battery and the power feeding device (Step S67). After performing this displaying, the elevator control panel 10 ends the manual search processing.

As described above, according to the elevator system of this example, when an abnormal state in which the power feeding point cannot be detected occurs even if the car 1 stops at the power feeding floor, the processing of searching for the power feeding point by the automatic search is first performed, and the return to the normal operation can be automatically performed. For example, even in a case where the accurate position of the car 1 is not known on the elevator control panel 10 side due to the occurrence of an earthquake or a temporary power failure, the occurrence of an abnormality in communication between the elevator control panel 10 side and the car 1, or the like, the power feeding point is searched by the automatic search, and the return to the normal operation can be automatically performed. Further, even when the power feeding point cannot be temporarily detected due to dust or the like generated in the elevator hoist way, the power feeding point is searched by the automatic search, and the return to the normal operation can be automatically performed. Therefore, it is possible to automatically return to the normal operation without dispatching a maintenance person, and the reliability of the elevator that performs the wireless power transfer is improved.

In addition, in a case where the power feeding point cannot be detected by the automatic search due to an abnormality of a sensor for position detection installed in the car 1 or the like, the process proceeds to the manual search, and the power feeding point can be searched by manual operation by the maintenance person of the building or the maintenance person of the management company. Therefore, even if a situation in which the power feeding point cannot be detected by the automatic search occurs, it is possible to cope with the situation by manual operation.

### [6. Example of Power Feeding and Rescue Using Another Car]

FIG. 8 illustrates an example of power feeding and passenger rescue in a case where there are a plurality of cars performed in Step S53 of the flowchart of FIG. 6.

In the example of FIG. 8, two cars 1a and 1b are arranged in the hoist way 22, and in a normal state, the cars 1a and 1b ascend and descend individually.

One car 1a stops at landings 11-la to 11-4a of the respective floors. The other car 1b stops at landings 11-1b to 11-4b of the respective floors.

In addition, power receiving devices 3a and 3b are installed in the cars 1a and 1b, respectively, and can receive power from the power feeding device 2 (not illustrated in FIG. 8).

Further, power transmission and reception devices 8a and 8b for performing emergency power transmission are installed in the cars 1a and 1b, and when the two cars 1a and 1b stop on the same floor, power transmission can be performed between the two power transmission and reception devices 8a and 8b in a non-contact manner.

Further, emergency openings 9a and 9b are installed in the cars 1a and 1b, respectively. Then, in a state where the two cars 1a and 1b are stopped at the same position, by opening emergency openings 9a and 9b, it is possible to rescue passengers from one car 1a to the other car 1b or from the other car 1b to the one car 1a.

In this way, the power can be contactless transmitted between the two cars 1a and 1b, whereby the main battery 4 and the auxiliary battery 5 of each of the cars 1a and 1b can be charged even when there is an abnormality in one of the power receiving devices 3a and 3b. In addition, passenger rescue can be performed between the two cars 1a and 1b, and door abnormality or the like can be handled.

### [7. Modification]

The present invention is not limited to the above embodiments, but various modifications may be contained.

For example, in the above-described embodiment, the car 1 includes the main battery 4 and the auxiliary battery 5. On the other hand, auxiliary battery 5 may be omitted, and a part of capacity of main battery 4 may be used as reserve battery.

In addition, the above-described embodiments have been described in detail for clear understating of the invention, and are not necessarily limited to those having all the described configurations. In addition, in the configuration diagrams of FIG. 1 and the like, only control lines and information lines considered to be necessary for explanation are illustrated, but not all the control lines and the information lines for a product are illustrated. In practice, almost all the configurations may be considered to be connected to each other. Further, in the flowcharts illustrated in FIGS. 5 to 7, the execution order of some processing steps may be changed or some processing steps may be executed simultaneously within a range not affecting the processing result of the embodiment.

In addition, the configurations described in the embodiments may be realized in software such that a processor interprets and performs a program which realizes each function. The information of programs or the like to realize the functions may be stored in a memory, a recording device such as a hard disk, a solid state drive (SSD), or a recording medium such as an IC card, an SD card, and an optical disk.

### REFERENCE SIGNS LIST

1, 1a, 1b car
2, 2a, 2b power feeding device
3, 3a, 3b power receiving device
4 main battery
5 auxiliary battery
6 car control device
7 car position correction switch
8a, 8b power transmission and reception device
9a, 9b emergency opening
10 elevator control panel
11-1 to 11-4, 11-1a to 11-4a, 11-1b to 11-4b landing
21, 22 hoist way
101 battery capacity check unit
102 information guide unit
103 information transmission unit (car side)
104 indicator
111 information transmission unit (control panel side)
112 power feeding floor movement determination unit
113 power feeding floor movement command unit
114 external information transmission unit
110 external communication/operation unit
C computer
C1 CPU
C2 ROM
C3 RAM
C4 nonvolatile storage
C5 network interface
C6 input device
C7 display device
C8 bus

1. An elevator system, comprising:
an elevator car configured to ascend and descend a hoist way;
a power feeding device installed at a specific power feeding point of the hoist way;
a power receiving device installed in the car and configured to receive power from the power feeding device when the car stops at the power feeding point;
a battery charged with power received by the power receiving device; and
an elevator control panel that controls ascent and descent of the car,
wherein, when the battery has a predetermined remaining capacity or less, the elevator control panel performs a rescue operation of a passenger in the car, and after the rescue operation, performs an automatic search operation of searching for the power feeding point where the power feeding device is installed according to the remaining capacity of the battery.

2. The elevator system according to claim 1, wherein when the power feeding point at which the power feeding device is installed cannot be detected in the automatic search operation, the elevator control panel searches for the power feeding point by raising or lowering a predetermined range with a current position of the car as a starting point in a state where a speed is limited.

3. The elevator system according to claim 2, wherein
the car control device raises or lowers the car to a place where the car position correction mechanism is installed in a case where the power feeding point cannot be detected by raising or lowering in a state where the speed is limited, and
after the correction using the car position correction mechanism, the elevator control panel performs an automatic search operation of searching for the power feeding point.

4. The elevator system according to claim 3, wherein when the car position correction mechanism cannot correct the car position, the elevator control panel searches for the power feeding point by operating the car around the hoist way once in a state where the speed is limited.

5. The elevator system according to claim 1, wherein when a plurality of cars is installed in the hoist way, the elevator control panel sets a plurality of cars at substantially the same elevating position, and supplies power from one car to the other car.

6. The elevator system according to claim 1, wherein
an operation unit is directly or remotely connected to the elevator control panel, and
when the power feeding point cannot be detected in the automatic search operation, the elevator control panel performs a manual operation of the car on a basis of an instruction in the operation unit.

7. The elevator system according to claim 6, wherein during the manual operation, the elevator control panel notifies the operation unit of an estimated position of the car, a moving direction to the power feeding point, and a remaining distance.

8. The elevator system according to claim 1, wherein
the car includes:
a battery capacity check unit that checks a capacity of the battery;
an indicator configured to notify a passenger of the rescue operation during the rescue operation; and
a car-side information transmission unit that communicates with the elevator control panel, and
the elevator control panel includes:
a control panel side information transmission unit that communicates with the car;
a power feeding floor movement determination unit that determines movement to a floor where the power feeding point is installed; and
a power feeding floor movement command unit that gives a command to move the car to a floor where the power feeding point is installed.
